(19) United States
(12) Patent Application Publication
(10) Pub. No.: US 2023/0397600 A1
(43) Pub. Date: Dec. 14, 2023

(54) TREE ASCENT APPARATUS

(71) Applicant: Double Dragon International, Inc., Dubuque, IA (US)

(72) Inventor: Randy L. Schofield, Harrisburg, MO (US)

(21) Appl. No.: 17/839,105

(22) Filed: Jun. 13, 2022

(51) Int. Cl. A01M 31/02; A63B 27/00

(52) U.S. Cl. CPC A01M 31/02; A63B 27/00

(57) ABSTRACT

A tree ascent apparatus may include a post, an extension supported by the post in a lock wedge. The extension has an aperture receiving the post. The lock wedge has a tapered surface. The lock wedge is jammed in the aperture between the post and the extension.

### CROSS-REFERENCE TO RELATED PATENT APPLICATIONS

The present application is related to co-pending U.S. patent application Ser. No. ______ (Atty. Dkt. No. D100-159) filed on the same day here with by Randy L. Schofield and entitled TREE CLIMBING SYSTEM, the full disclosure of which is hereby incorporated by reference.

### BACKGROUND

Tree ascent apparatus are used to ascend a tree or remain ascended in a tree. One example of a tree ascent apparatus is a tree climbing stick. Tree climbing sticks are typically mounted along a tree and serve as a ladder for a person to reach a higher tree stand for wildlife observation or hunting. Another example of a tree ascent apparatus is a tree stand. Tree stands typically include a platform upon which a person may stand. Some tree stands additionally include a secondary platform that serves as a seat. As such tree climbing sticks and/or tree stands are often used in remote areas, transporting such tree climbing sticks and tree stands is often difficult.

### BRIEF DESCRIPTION OF THE DRAWINGS

FIG. 1 is a sectional view illustrating portions of an example tree ascent apparatus.

FIG. 2 is a sectional view illustrating portions of an example tree ascent apparatus.

FIG. 3 is a sectional view illustrating portions of an example tree ascent apparatus.

FIG. 4 is a sectional view illustrating portions of an example tree ascent apparatus.

FIG. 5 is a perspective view of an example tree ascent apparatus.

FIG. 6 is an exploded perspective view of the tree ascent apparatus of FIG. 5.

FIG. 7 is a perspective view of an example claw, lock wedge and fastener of the tree ascent apparatus of FIG. 5.

FIG. 8 is a sectional view of the tree ascent apparatus of FIG. 5 taken along line 8-8.

FIG. 9 is an enlarged sectional view of a left portion of the tree ascent apparatus of FIG. 8.

FIG. 10 is an enlarged sectional view of a right portion of the tree ascent apparatus of FIG. 8.

FIG. 11 is a perspective view of an example claw, lock wedge and fastener for use as part of the tree ascent apparatus of FIG. 5.

FIG. 12 is a perspective view illustrating portions of an example tree ascent apparatus.

FIG. 13 is a perspective view of the example tree ascent apparatus of FIG. 12.

FIG. 14 is a sectional view of an upper portion of the tree ascent apparatus of FIG. 12 taken along line 14-14.

FIG. 15 is a sectional view of a lower portion of the tree ascent apparatus of FIG. 12 taken along line 14-14.

FIG. 16 is a perspective view illustrating portions of an example tree ascent apparatus.

FIG. 17 is a sectional view of an upper portion of the example tree ascent apparatus of FIG. 16 taken along line 17-17.

FIG. 18 is a sectional view of a lower portion of the example tree ascent apparatus of FIG. 16 taken along line 17-17.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example tree ascent apparatus that are configured so as to be of lower cost construction and lighter weight. The lighter weight of such tree ascent apparatus may facilitate easier of transporting such apparatus to remote areas. The disclosed example tree ascent apparatus have a configuration that more securely connects various extensions, such as a step, a claw, a platform and/or a seat, to tubular post in a fashion such that prolonged wear of the tube is reduced and such that the tube may be formed from lighter weight materials and/or may have a thinner wall thickness.

The example tree ascent apparatus comprises a tubular post and an extension supported by the post. The tubular post may have a cylindrical cross-section, an oval cross-section or a polygonal cross-section. The extension may be in the form of a tree gripping claw, a step, a platform or a seat. The extension has an aperture that receives the post.

A lock wedge having a tapered surface is jammed in the aperture between the post and the extension. The term “jammed” means that the lock wedge is tightly fit in contact with both the interior surfaces of the aperture and the exterior surfaces of the post. The lock wedge occupies and fills any gaps between the interior of the aperture and the exterior of the post. Because the lock wedge is tapered, the lock wedge may accommodate any variations in the size of the gap between the interior surface of the aperture and the exterior surface of the post caused by manufacturing and tolerance variations. As result, the post and the extension may be manufactured with less precise manufacturing processes, reducing manufacturing cost.

Because the lock wedge occupies and fills any gaps between the interior surfaces of the aperture and the exterior surfaces of the post, the lock wedge inhibits relative movement of the extension with respect to the post. Inhibiting or limiting such relative movement reduces rattling or other noise which might otherwise impair wildlife observation or hunting. Moreover, inhibiting or limiting such relative movement reduces those forces upon the post which tend to damage the post over prolonged periods of time. Because the construction may make the post and extension more robust, the post may be formed from a different lighter weight material that might otherwise be more subject to wear, such as a carbon fiber material, or may be formed from a metal, such as aluminum, wherein the wall thickness of the post may be reduced to reduce the overall weight of the tree ascent apparatus.

In some implementations, the tree ascent apparatus further comprises a fastener that extends through extension, through the lock wedge and through the post. In some implementations, the fastener completely extends through opposite side walls of both the lock wedge and the post. In some implementations, the fastener comprises an externally threaded shaft, wherein the externally threaded shaft is screwed into an internally threaded bore formed in the extension or is threaded or screwed into a nut after passing through a portion of the extension. In some implementations, the fastener may comprise a bolt. In some implementations the fastener may comprise a spring pin, also referred to as a roll pin.

The example tree ascent apparatus may further facilitate easier construction or manufacture of the tree ascent apparatus. In some implementations, the post is inserted through the aperture in the extension, configured as one of a platform, a seat, a tree gripping claw and a step. The lock wedge is jammed into the aperture between the post and the extension. In some implementations, a cylindrical pounding tube may be slid over the post and into contact with a top or bottom edge of the lock wedge, wherein the cylindrical pounding tube may be pounded to drive and jam the lock wedge between the interior surfaces of the aperture and the exterior surfaces of the post. Thereafter, the cylindrical pounding tube may be withdrawn. In some implementations, an adhesive, such as an epoxy, may be coated on the interior surface of the aperture or on surfaces of the lock wedge, wherein drying or curing of the adhesive further assists in retaining the lock wedge in place.

In some implementations, the extension may have a pair of preformed bores that are aligned with one another on opposite sides of the aperture. Such preformed bores may include an entry bore and an exit bore. Following positioning of the post into or through the aperture and following the jamming of the lock wedge between the post and the interior surfaces of the aperture, a fastener passage may be drilled through the lock wedge and through the post. During such drilling, the entry bore may receive the drill bit, serving as a guide during such drilling, aligning the passage with the opposite exit bore. Thereafter, the fastener may be inserted through the preformed bores and through the drilled passage.

FIG. 1 is a sectional illustrating portions of an example tree ascent apparatus 20. Tree ascent apparatus may be in the form of a tree climbing stick or a tree stand having a platform. In some implementations, the tree stand may additionally include a seat. Tree ascent apparatus 20 is configured so as to be of lower cost construction and lighter weight. The lighter weight of tree ascent apparatus 20 may facilitate easier of transporting such apparatus to remote areas. Tree ascent apparatus 20 has a configuration that more securely connects various extensions, such as a step claw, a platform and/or a seat, to tubular post in a fashion such prolonged wear of the tube is reduced and such that the tube may be formed from lighter weight materials and/or may have a thinner wall thickness. Tree ascent apparatus 20 comprises post 30, extension 36 and lock wedge 40.

Post 30 comprises an elongate tubular structure configured for extending generally along a tree trunk while supporting at least one extension, such as extension 36. Post 30 may be secured against the tree trunk by one or more claws, straps or the like. Post 30 may have a circular, oval or polygon cross-sectional shape with a hollow interior. In some implementations, the hollow interior may be filled with another material such as a foam. Post 30 may be formed from a non-fiber material that is a lower density and is lighter in weight than a metal material or a metal but wherein post 30 has a reduced wall thickness, taking advantage of the additional structural integrity provided by lock wedge 40. In some implementations, post 30 is formed from an aluminum or aluminum alloy and has a wall thickness of no greater than 6 mm.

Extension 36 comprise a structure that is supported by post 30 and projects sideways or outwardly from post 30. In the example illustrated, extension 36 extends horizontally from post 30, in a plane that is perpendicular to the longitudinal axis of post 30. In other implementations, extension 36 may extend at an oblique angle from post 30. Extension 36 may be in the form of a claw, a step, a platform or a seat. In some implementations, the extension may concurrently serve as both a claw and step, a claw and a platform or a claw and a seat.

Extension 36 comprises an aperture 60 sized or configured to receive post 30. In the example illustrated, aperture 60 is sufficiently large such that post 30 may extend completely through aperture 60. In the example illustrated, aperture 60 tapered, the interior diameter of aperture 60 gradually changes in a sloped manner, changing from a wider diameter to a smaller diameter. The tapering of aperture 60 facilitates reception of lock wedge 40 and facilitates the ability of lock wedge 40 to accommodate manufacturing variations in the size of aperture 60 and the outer diameter of post 30.

Lock wedge 40 comprises an annular structure or ring having an inner surface 70 and an outer surface 72. Inner surface 70 has a shape corresponding to the outer surface shape of post 30. In the example illustrated, inner surface 70 has an internal diameter slightly larger than the outer diameter of post 30. In one implementation, post 30 has a circular cross-section, wherein surface 70 has a circular cross-section.

Outer surface 72 has a shape corresponding to the inner surface shape of aperture 60. In the example illustrated, outer surface 72 has a taper that matches corresponds to the taper of aperture 60. Outer surface 72 is sized such that lock wedge 40 may be inserted into aperture 60 and jammed between post and the interior surfaces of aperture 60 of extension 36.

In the example illustrated, lock wedge 40 comprises a split ring or cylinder having a slot that extends along its longitudinal length. The slot permits the inner and outer diameter of lock wedge 40 to change as it is jammed between post 30 and extension 36. The slot may facilitate a tighter frictional contactor grip between lock wedge 40 and the engaged post 30 and extension 36. In some implementations, the slot may be omitted.

Because the lock wedge 40 occupies and fills any gaps between the interior surfaces of the aperture 60 and the exterior surfaces of the post 30, the lock wedge 40 inhibits relative movement of the extension 36 with respect to the post 30. Inhibiting or limiting such relative movement reduces rattling or other noise which might otherwise impair wildlife observation or hunting. Moreover, inhibiting or limiting such relative movement reduces those forces upon the post which tend to damage the post 30 over prolonged periods of time. Because the construction may make the post 30 and extension 36 more robust, the post may be formed from a different lighter weight material that might otherwise be more subject wear, such as a carbon fiber material, or may be formed from a metal, such as aluminum, wherein the wall thickness of the post may be reduced to reduce the overall weight of the tree ascent apparatus 20.

The example tree ascent apparatus 20 may further facilitate easier construction or manufacture of the tree ascent apparatus. In some implementations, post 30 is inserted through the aperture 60 in the extension 36, configured as one of a platform, a seat, a tree gripping claw and a step. The lock wedge 40 is jammed into the aperture 60 between the post 30 and the extension 36. In some implementations, a cylindrical pounding tube may be slid over the post 30 and into contact with a top or bottom edge of the lock wedge 40, wherein the cylindrical pounding tube may be pounded to drive and jam the lock wedge between the interior surfaces of the aperture 60 and the exterior surfaces of the post 30. Thereafter, the cylindrical pounding tube may be withdrawn. In some implementations, an adhesive, such as an epoxy, may be coated on the interior surface of the aperture 60 or on surfaces of the lock wedge 40, wherein drying or curing of the adhesive further assists in retaining the lock wedge 40 in place.

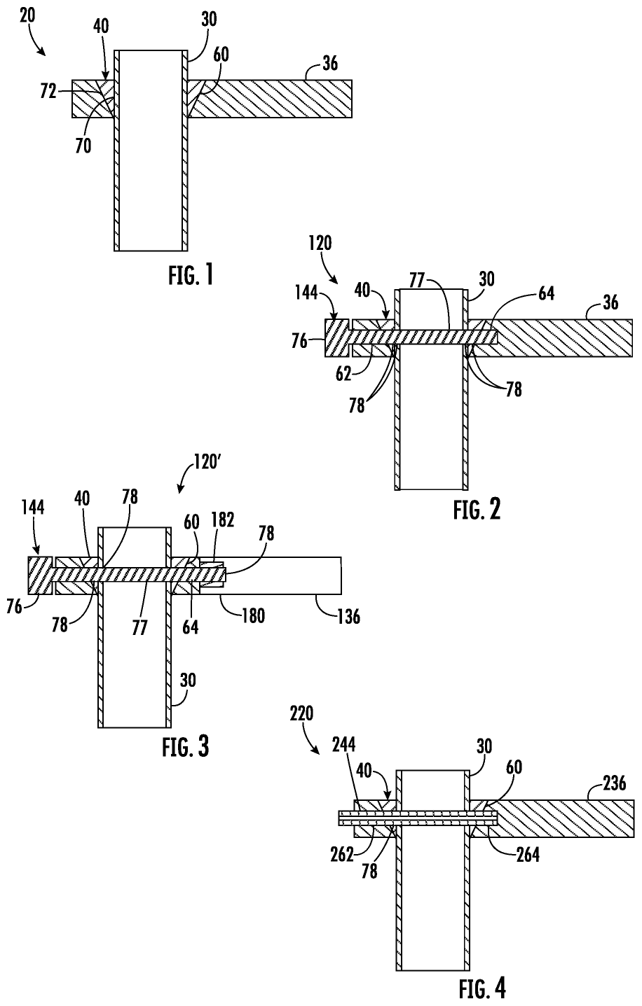

FIG. 2 is a sectional view schematically illustrating portions of an example tree ascent apparatus 120. FIG. 2 illustrates an example of how an additional fastener may be employed to further retain extension 36 axially along post 30. Tree ascent apparatus 120 is similar to tree ascent apparatus 20 except that tree ascent apparatus additionally comprises fastener 144. Fastener 144 extends at least partially through extension 36, at least partially through lock wedge 40 and at least partially through post 30. For example, fastener 144 extends through at least one side of extension 36, lock wedge 40 and post 30. In the example illustrated, fastener 144 extends through and at least into extension 36 on opposite sides of aperture 60. Fastener 144 extends through opposite sides of lock wedge 40. Fastener 140 extends through opposite sides of post 30. As a result, lock wedge 40 is inhibited from axial movement along post 30 and loosening. In some implementations, fastener 144 may be omitted.

In the example illustrated, fastener 144 comprises a threaded bolt having a head 76 and an externally threaded shaft 77. Shaft 77 passes through an entry bore 62 formed in extension 36, through lock wedge 40, through post 30 and into an exit bore 64 formed in extension 36. In the example illustrated, exit bore 64 is internally threaded for threaded engagement with the external threads of shaft 77. In some implementations, entry bore 62 may also be internally threaded. In other implementations, entry bore 62 may comprise an unthreaded bore.

In some implementations, the extension 36 may have a pair of preformed bores 62, 64 that are aligned with one another on opposite sides of the aperture 60. Following the insertion of the post 30 into or through the aperture 60 and following the jamming of the lock wedge 40 between the post 30 and the interior surfaces of the aperture 60, a fastener passage 78 may be drilled through the lock wedge 40 and through the post 30. During such drilling, the entry bore 62 may receive the drill bit, serving as a guide during such drilling, aligning the passage 78 with the opposite exit bore 64. Thereafter, the fastener 144 may be inserted through the preformed bores 62, 64 and through the drilled passage 78.

FIG. 3 is a sectional view schematically illustrating portions of an example tree ascent apparatus 120′. FIG. 3 illustrates an example of another fastener that may be employed to further secure extension 36 to post 30. Tree ascent apparatus 120′ is similar to tree ascent apparatus 120 except that exit bore 64 is not necessarily internally threaded and that extension 36 comprises an opening 180 sized to receive a nut 182 that may be threaded onto the externally threaded shaft 78 of fastener 144. Use of nut 182 may facilitate a less complex and lower cost extension 36.

FIG. 4 is a sectional view illustrating portions of an example tree ascent apparatus 220. FIG. 3 illustrates example of another fastener that may be used in place of the bolt shown in FIG. 2. Tree ascent apparatus 220 is similar to tree ascent apparatus 120 except that tree ascent apparatus 220 comprises extension 136 and a fastener 244 in the form of a spring pin (also known as a roll pin). Those components of tree ascent apparatus 220 which correspond to components of tree ascent apparatus 120 are numbered similarly.

Extension 236 is similar to extension 36 described above except that exit bore 264 is not internally threaded. Rather, entry and exit bore 262 and 264 comprise smooth cylindrical openings paying internal timbre slightly less than the uncompressed diameter of the spring pin serving as fastener 244.

Fastener 244 extends at least partially at least partially through extension 36, through lock wedge 40 and at least partially through post 30. For example, fastener 244 extends through at least one side of extension 36, lock wedge 40 and post 30. In the example illustrated, fastener 244 extends through and at least into extension 236 on opposite sides of aperture 60. Fastener 244 extends through opposite sides of lock wedge 40. Fastener 244 extends through opposite sides of post 30. As a result, lock wedge 40 is inhibited from axial movement along post 30 and loosening.

In some implementations, the extension 36 may have a single preformed bore 262. Following the insertion of the post 30 into or through the aperture 60 and following the jamming of the lock wedge 40 between the post 30 and the interior surfaces of the aperture 60, a fastener passage 78 may be drilled through the lock wedge 40, through the post 30 and into the other side of extension 136 forming exit bore 264. During such drilling, the entry bore 62 may receive the drill bit, serving as a guide during such drilling, aligning the passage 78 with the opposite exit bore 264. Thereafter, the fastener 244 may be inserted through the preformed bore 262 and through the drilled passage 78 and the drilled exit bore 264. In other implementations, exit bore 264 may be preformed in extension 236, wherein such drilling merely forms passage 78.

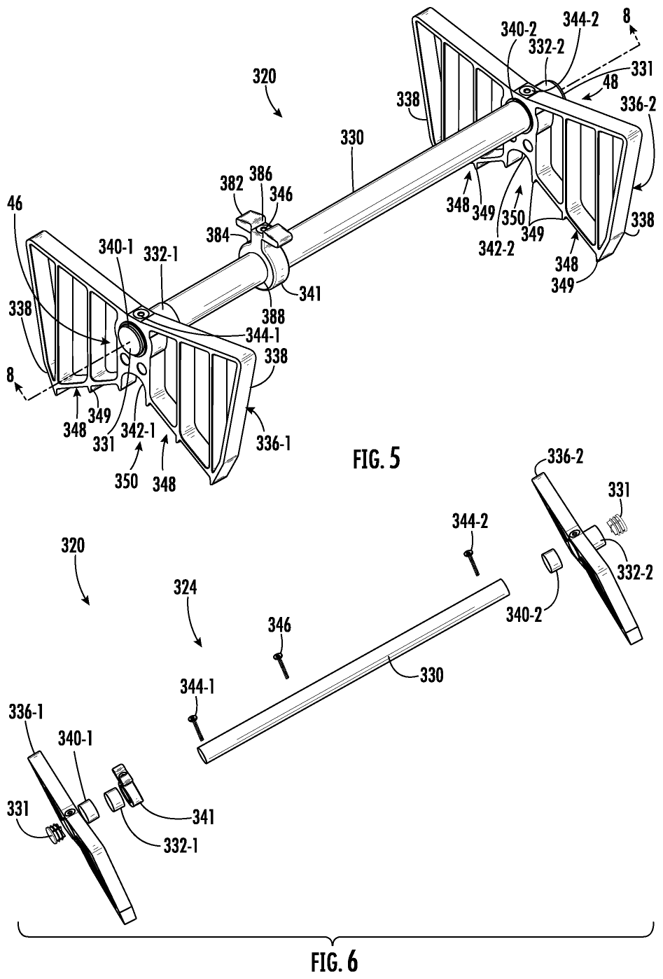

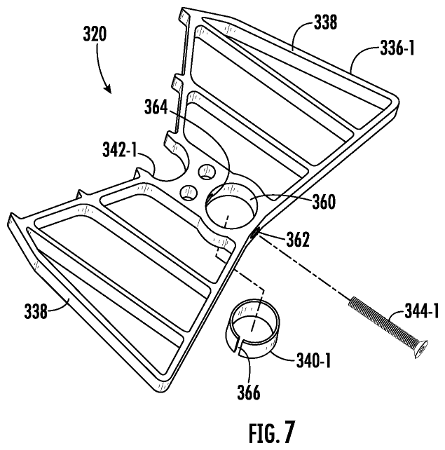

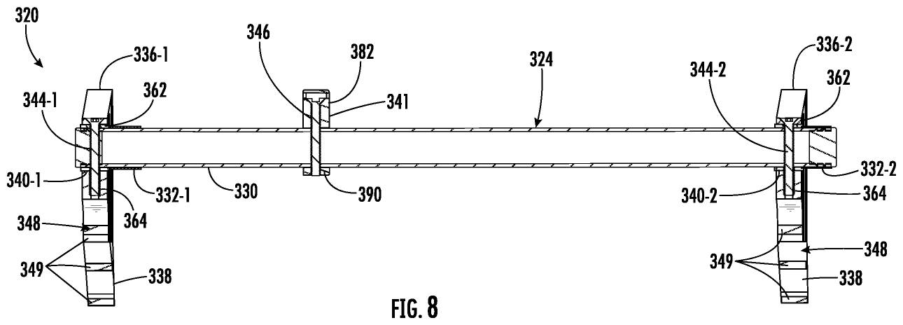

FIGS. 5 and 6 illustrate an example tree ascent apparatus 320 in the form of a climbing stick 324. FIG. 7 is an exploded perspective view of the tree ascent apparatus 320 shown in FIG. 5. In some implementations, the example tree ascent apparatus 320 may include multiple similar or identical climbing sticks 324 which may be stacked and releasably held together for transport and storage. Tree ascent apparatus 320 comprises post 330, caps 331, inwardly compressible layers 332-1, 332-2 (collectively referred to as layers 332), claws 336-1, 336-2 (collectively referred to as claws 336), lock wedges 340-1, 340-2 (collectively referred to as lock wedges 340), cleat 341, fasteners 344-1, 344-2 (collectively referred to as fasteners 344), and fastener 346.

Post 330 comprises a structure interconnecting and supporting claws 336. Post 330 may comprise an elongate tube having a circular, oval or polygonal cross-section. Post 330 may be formed from a metal, such as aluminum, a polymer or other material such as a carbon fiber material. Post 330 has a length of at least 100 mm and no greater than 1000 mm so as to support claws 336 for supporting steps along a tree.

Caps 331 fit within the hollow tubular axial ends of post 330 to close or plug such open ends. In some implementations, caps 331 may be omitted.

Inwardly compressible layers 332 extend along exterior portions of post 330. Layers 332 are formed from a resiliently compressible material such as a rubber or rubber-like material. Examples of the material from which layers 332 are formed include, but are not limited to, urethane, polytetrafluoroethylene (TEFLON), nylon, fabric, plastic. Layers 332 are configured to be inwardly compressed while releasably retaining another climbing stick in a stacked relationship to climbing stick 324. Layers 332 may have a Shore A durometer of no greater than 100 for securing an adjacent stacked climbing stick.

In the example illustrated, each of layers 332 comprises a tube or sleeve of resiliently compressible material that is slid over and along post 330 to a selected location and then is heat shrunk about the post 330 to secure the layer 332 in place. In some implementations, an additional layer of adhesive may be applied between each of layers 332 and post 330. In the example illustrated, post 330 has a cylindrical cross-section and a uniform diameter along its length, wherein the combined diameter of post 330 and an individual layer 332-1 or 332-2 is equal to the diameter of post 30 and twice the thickness of the heat shrunk sleeve wall providing layer 332-1 or 332-2.

In some implementations, layers 332 may each comprise a rubber, rubber-like, compressible polymer or fabric tape wrapped about post 330. In some implementations, the tape may include an adhesive for further securement of the tape about post 330. In some implementations, the tape may be elastic, being stretched about post 330 and having its end adhesively secured. In some implementations, the tape wrapped about post 330 may form a single layer of material. In some implementations, the tape may be wrapped about itself such that layers 332 is composed of multiple overlapping layers.

In some implementations, post 330 may have a slightly recessed or smaller diameter in those portions that are to underlie layers 332-1 and 332-2, wherein such circumferential recesses assist in locating the individual sleeves forming layers 332 prior to the heat shrinking of the sleeves. Such recesses may further assist in inhibiting axial sliding of the sleeves following the drinking of the sleeves. In such implementations, the recess may have a depth less than the thickness of the sleeve such that layers 332 projects beyond the surrounding exterior surface of post 330.

In other implementations, layers 332 may be formed and/or secured to post 330 in other fashions. For example, in some implementations, the sleeves forming layers 332 may not be heat shrunk but may be merely adhesively bonded or joined to post 330. In some implementations, the sleeves forming layers 332 may not be heat shrunk but may be slid along post 330 until being resiliently snapped or popped into the circumferential recesses formed in post 330. In some implementations, the circumferential recesses into which the sleeves forming layers 332 are resiliently popped may include an adhesive for further securing and retaining the sleeves within the recesses in selected axial positions along post 330. In some implementations, post 330 may include apertures at selected locations along post 330, whereas the sleeves forming layer 332 may include projections or plugs extending from the inner diameter of the sleeve, wherein the projections or plugs are resiliently popped or snapped into the apertures to axially retain the sleeves in place along post 330. In some implementations, layers 332 may be coated upon or molded about post 330.

In the example illustrated, layers 332 continually extend about the exterior of post 330, at the selected axial locations, without interruption. In other implementations, layers 332 may include such interruptions about the circumference of post 330. In some implementations, each of layers 332 may include multiple circumferentially spaced segments or bands which are circumferentially spaced apart from one another about post 330 or partially about post 330, such as on one side of post 330.

Claws 336 are secured to post 330 at axially spaced positions along post 330. Claws 336 are configured to engage the side of a tree to grip the tree and assist in retaining the climbing stick along the tree. In some implementations, claws 336 may include a series of teeth to assist in gripping the bark or sides of a tree. Claws 336 may include a pair of diverging and angled wings 338 forming a pair of angled toothed edges 348 having teeth 349, wherein the toothed edges 348 extend away from post 330 to form a tree receiving opening 350 adjacent the convex side of the angled wings.

To facilitate stacking and retention of multiple similar climbing sticks 324 in an axially offset relationship, layers 332 and claws 336 are not symmetrically located along the axis of post 330. Claw 336-1 is coupled to post 330 between layer 332-1 and the axial end 46 of post 30. In contrast, claw 36-2 is coupled to post 330 between layer 332-2 and the axial end 46 of post 330. In other words, layer 332-2 is between claw 336-2 and the end 48 of post 330.

In the example illustrated, claws 336 are configured so as to concurrently serve as steps for climbing stick 324. In the example illustrated, claws 336 are coplanar with such steps. In the example illustrated, claws 336 may be integrally formed as single unitary bodies with each of the corresponding steps. In some implementations, claws 336 are separate and distinct from steps supported by post 330 generally between claws 336. For example, additional steps may be integrally formed as part of post 330 or individually mounted to post 330.

Each of claws 336 further comprises an open sided channel sized to receive a portion of an inwardly compressible layer of another similar climbing stick 324. Claws 336-1 and 336-2 comprise open sided channels 342-1 and 342-2 (collectively referred to as channels 342), respectively, which are sized to receive and resiliently compress portions of inwardly compressible layer 332-1 and 332-2 of another climbing stick 324. For example, in some implementations, each of channels 342 may have a radius less than the radius of the outer surface of the corresponding layer 332. In the example illustrated, channels 342 are formed on the concave side of claws 336, so as to face towards the tree when the climbing stick is in use along the tree.

Lock wedges 340 and fasteners 344 secure claws 336 in place along post 330. FIG. 8 is an enlarged view of claw 336-1, lock wedge 340-1 and fastener 344-1. Claw 336-2, lock wedge 340-2 and fastener 344-2 are similar. As shown by FIG. 7, claw 336-1 comprises an aperture 360, entry bore 362 and internally threaded bore 364.

Aperture 360 extends through claw 336-1 at a location between wings 338 and aligned with channel 342-1. Aperture 360 is tapered, having an inner diameter that narrows along its axial length. Entry bore 362 and internally threaded bore 364 extend on opposite sides of aperture 360. In the example illustrated, entry bore 362 comprise a countersunk bore to receive the head of fastener 344-1 and extends to the interior of aperture 360, being aligned with internally threaded bore 364. Internally threaded bore 364 extends from aperture 360 towards channel 342-1. In the example illustrated, internally threaded bore 364 comprises a blind hole. In other implementations, bore 364 may extend through claw 336-1 to communicate with the interior of channel 342-1. Internally threaded bore 364 is internally threaded to threadably receive the threads of fastener 344-1.

Lock wedge 340-1 comprises a split tube or ring having an axial slot 366. Lock wedge 340-1 has an inner shape that corresponds to the outer surface shape of post 330. Lock wedge 340-1 has an outer shape that corresponds to the interior surface shape of aperture 360. In the example illustrated in which aperture 360 is tapered, the outer surface of wedge 340-1 has a correspondingly tapered outer surface. The outer surface of wedge 341 has a first diameter at one axial end and narrows to a second smaller diameter at the opposite axial end. Although aperture 360 and the outer surface of lock wedge 340-1 are both illustrated as having circular cross-sections, in other implementations, aperture 360 and the outer surface of lock wedge 340-1 may have other corresponding cross-sectional shapes such as oval or polygonal cross-sectional shapes.

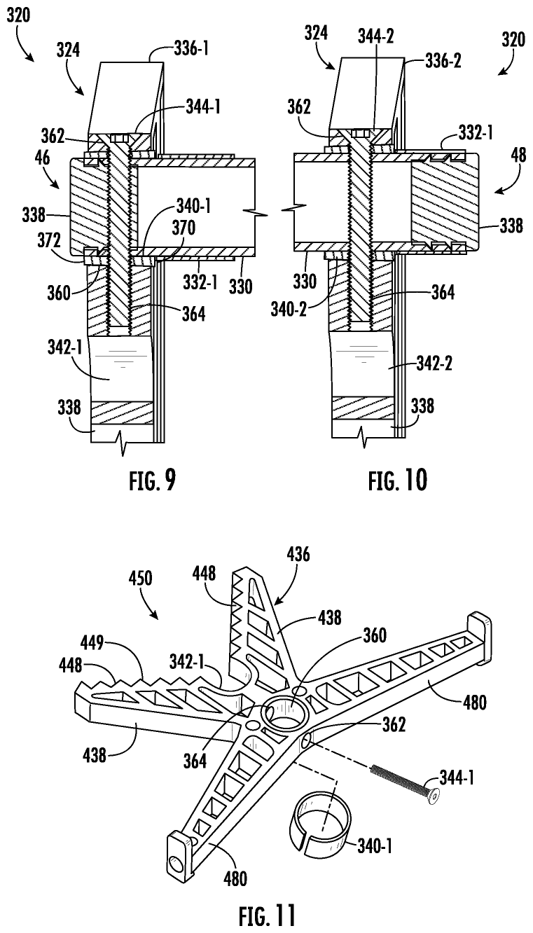

FIGS. 9 and 10 are sectional views illustrating lock wedge 340-1 and fastener 344-1 securing claw 336-1 to post 330. FIG. 10 is an enlarged view of the left side of climbing stick 324 as seen in FIG. 8. As shown by FIG. 9, lock wedge 340-1 has a uniform inner diameter along its length and has an outer diameter that tapers are narrows from a first end 370 to a second opposite end 372. In the example illustrated, aperture 360 has a corresponding taper. Lock wedge 340-1 is wedged between post 330 and the interior surface of aperture 360. Lock wedge 340-1 forms a tight fit between post 330 and the interior surfaces of aperture 360, accommodating or filling any spaces that may result from manufacturing variations or tolerances. Because lock wedge 340-1 is in close abutting contact with both the exterior surface of post 330 and the interior surfaces of aperture 360, lock wedge 340-1 inhibits any relative movement between post 330 and claw 336-1, reducing noise and reducing abrasion or wear of claw 336-1 and post 330. Because lock wedge 340-1 accommodates any manufacturing variations or tolerances, the manufacturer post 330 and claw 336-1 may be less precise, permitting the manufacture of post 330 and claw 336-1 to be less complex and less expensive. Because lock wedge 340-1 reduces relative movement between post 330 and claw 336-1, lock wedge 340-1 reduces stress upon post 330 and potential deformation or wear of post 330 that might be otherwise be caused by such relative movement. As a result, post 330 may be formed from thinner and/or more lightweight materials. For example, in some implementations, lock wedge 340-1 may facilitate the use of a post 330 formed from aluminum and having a wall thickness of less than 1 mm, reducing both cost and weight. In some implementations, lock wedge 340-1 may facilitate the use of a post 330 formed from a carbon fiber, reducing the weight of climbing sticks 324.

In some implementations, lock wedge 340-1 is initially slid over post 330. Thereafter, post 330 and the surrounding lock wedge 340-1 are inserted into aperture 360. A cylindrical wedging tool having an interior diameter greater than the exterior diameter of post 330 but less than the exterior diameter of lock wedge 340-1 may be positioned over post 330 and axially pounded to drive lock wedge 340-1 between post 330 and the interior surface of aperture 360 of claw 336-1. In other implementations, lock wedge 340-1 may be secured between claw 336-1 and post 330 in other fashions. Lock wedge 340-2 may be similarly positioned between post 330 and aperture 360 of claw 336-2.

As further shown by FIG. 9, fastener 344-1 extends through entry port 362, through lock wedge 340-1, through post 330 and into internally threaded bore 364 to axially secure claw 336-1 along post 330. In the example illustrated, fastener 362 has a head received within a countersunk opening of entry bore 362 and is moved through cap 331 and threaded into bore 364. In some implementations, once post 330 has been inserted through aperture 360 and once lock wedge 345 1 has been wedge between post 330 and claw 336-1, a drill may be guided by entry bore 362 so as a drill through lock wedge 34-1, through post 330 and through cap 331 until reaching bore 364. Thereafter, fastener 344-1 is passed through entry bore 362 and through the drilled bore until the threaded portion of fastener 344-1 may be threaded into bore 364.

FIG. 10 is an enlarged view of the right side of climbing stick 324 as seen in FIG. 8. As shown by FIG. 10, lock wedge 340-2 and fastener 344-2 are similar to lock wedge 340-1 and fastener 344-1, respectively. Lock wedge 340-2 and fastener 344-2 secure claw 336-2 to the right side of post 330 in a fashion similar to lock wedge 340-1 and fastener 344-1 as described above. As noted above, claw 336-1 is secured to post 330 between layer 332-1 and the axial end 46 of post 330. In contrast, claw 336-2 is secured to post 330 between layer 332-2 and the axial end 46 of post 330. This distinction facilitates the axial offset stacking of multiple similar identical climbing sticks 324.

Although fasteners 344 are illustrated as comprising externally threaded bolts which are threaded into internally threaded bore 364 provided in the respective claws 336, in other implementations, fasteners 344 may be secured in other fashions or may other configurations. For example, claw 336 may alternatively include an unthreaded bore in place of threaded bore 364 and may include a separate threaded nut for being threaded onto the end of fastener 344. In some implementations, each of fasteners 344 may comprise a spring pin, also referred to as a roll pin or tension pin, which has an outer diameter greater than the outer diameter of a passage extending through claw 336, lock wedge 340, and post 330 (in place of entry bore 362, threaded bore 364 and the drilled or otherwise formed intermediate bore). The spring pin may be compressed during insertion and resiliently engages the interior of the passage so as to be retained in place, further axially securing claw 336 in place along post 330.

FIG. 11 is a perspective view illustrating an alternative claw 436 and the associated lock wedge 340-1 and fastener 344-1 which may be used as part of tree climbing stick 324 and as part of tree ascent apparatus 320 in place of claw 336-1, lock wedge 340-1 and fastener 344-1 described above. The illustrated claw 436 may likewise be used in place of claw 336-2 as part of apparatus 320 and as part of any of the other climbing sticks 324 of apparatus 320. Lock wedge 340-1 and fastener 344-1 are similar to the lock wedge 340-1 and fastener 344-1 used with claw 336-1.

Like claw 336-1, claw 436 is configured to serve as both a tree gripping claw and a step for the climbing stick. Claw 436 comprise wings 438 which include angled toothed edges 448 about a tree receiving opening 450. Edges 448 each include a series of teeth 449.

In contrast to claw 336-1, claw 436 includes more distinct step portions 480 which angle away from wings 438. Similar to claw 336-1, claw 436 comprises side opening channel 342-1, aperture 360, entry bore 362 and internally threaded bore 364 (described above). As with claw 336-1, claw 436 is secured to post 330 by wedging lock wedge 340-1 between the interior surfaces of aperture 360 and post 330. Thereafter, fast 344-1 is passed through a drilled opening formed in lock wedge 340-1 and post 330 and is threaded into internally threaded bore 364. As discussed above, in other implementations, other fasteners and configurations may be used in place of fastener 344-1 and the internally threaded bore 364. In some implementations, fasteners 344 may be omitted, wherein claws 336 or 436 are further axially secured by an adhesive or epoxy deposited or applied between post 330 and the interior surfaces of lock wedge 340-1.

As shown by FIGS. 5 and 8, cleat 341 projects from post 330 in a direction generally opposite to the direction in which side opening channels 342-1 and 342-2 face. Cleat 341 is secured to post 330 and has a head portion 382 and a narrower neck portion 384 about which a strap, rope, cable the like may be wrapped and retained. Head portion 382 comprises an axially extending notch 386 sized to partially receive the side of post 330 of another stacked climbing stick 324.

In the example illustrated, cleat 341 comprise a ring portion 388 that extends about post 330 and which is slid along post 330 to a desired location. At such a location, fastener 346 is passed through head portion 382 and through post 330, into and internally threaded bore 390 provided in the ring portion 388 (as shown in FIG. 8). In other implementations, cleat 341 may be secured to post 330 in other fashions such as with other fasteners, adhesives, C-clamps and the like. In some implementations, cleat 341 may be integrally formed as part of a single unitary body with post 330. In some implementations, cleat 341 may be omitted.

In some implementations, cleat 341 may be secured to post 330 using a lock wedge, similar to the lock wedge is used to secure claws 336 to post 330. In particular, cleat 341 may include an aperture, similar to aperture 360, which receives a lock wedge, similar to lock wedge 340-1 or 340-2, which is wedged between post 330 and the interior surfaces of the aperture. In some implementations, claws 336 and cleat 341 may be secured to post 330 using other constructions with or without lock wedges.

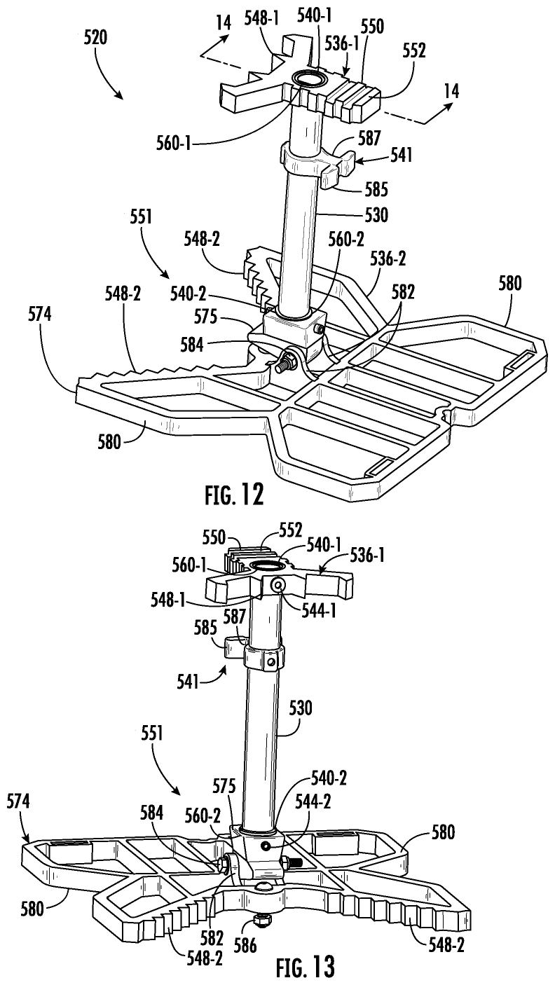

FIGS. 12-15 illustrate portions of an example tree ascent apparatus 520. FIGS. 12-15 illustrate an example of how the lock wedge and fastener described with respect to FIGS. 2-4 may be employed in a tree ascent apparatus in the form of a tree stand. Tree ascent apparatus or 520 comprises post 530, extensions 536-1, 536-2 (collectively referred to as extensions 536), lock wedges 540-1, 540-2 (collectively referred to as lock wedges 540), cleat 541, and fasteners 544-1 (shown in FIGS. 13 and 14) and 544-2 (shown in FIGS. 12-13 and 15) (collectively referred to as fasteners 544).

Post 530 is similar to post 30 described above. Post 530 comprises an elongate tubular structure that is configured to extend generally along a tree trunk while supporting extensions 536. Post 530 may be secured against the tree trunk by one or more claws, straps or the like. Post 530 may have a circular, oval or polygon cross-sectional shape with a hollow interior. In some implementations, the hollow interior may be filled with another material such as a foam. Post 530 may be formed from a non-fiber material that is a lower density and is lighter in weight than a metal material or a metal but wherein post 530 has a reduced wall thickness, taking advantage of the additional structural integrity provided by lock wedges 540. In some implementations, post 530 is formed from an aluminum or aluminum alloy and has a wall thickness of no greater than 6 mm.

Extensions 536 comprise structures that are supported by post 530 and projects sideways or outwardly from post 530. In the example illustrated, extensions 536 extends horizontally from post 530, in a plane that is perpendicular to the longitudinal axis of post 530. In other implementations, extension 36 may extend at an oblique angle from post 530.

In the example illustrated, extension 536-1 comprises a claw having a toothed edge 548 and a body 550 having an aperture 560-1 therethrough. Tooth edge 548 is configured to face the side of a tree and grip the side of the tree. Body 550 projects forwardly from tooth edge 548 and has a non-smooth surface 552 such that body 550 may, in some instances, serve as a step.

Aperture 560-1 extends through body 550 and sized or configured to receive post 530. In the example illustrated, aperture 560-1 is sufficiently large such that post 530 may extend completely through aperture 560. As shown by FIG. 14, aperture 560-1 is tapered, the interior diameter of aperture 560 gradually changes in a sloped manner, changing from a wider diameter to a smaller diameter. The tapering of aperture 560-1 facilitates reception of lock wedge 540-1 and facilitates the ability of lock wedge 540-1 to accommodate manufacturing variations in the size of aperture 560-1 and the outer diameter of post 530.

Lock wedges 540-1 and 540-2 are each similar to lock wedges 40 and 340 described above. Each of lock wedges 540 comprises an annular structure or ring having an inner surface 570 and an outer surface 572. Inner surface 570 has a shape corresponding to the outer surface shape of post 530. In the example illustrated, inner surface 570 has an internal diameter slightly larger than the outer diameter of post 530. In one implementation, post 530 has a circular cross-section, wherein surface 570 has a circular cross-section.

The outer surface 572 of lock wedge 540-1 has a shape corresponding to the interior surface of aperture 560-1 formed in extension 536-1. In the example illustrated, outer surface 572 has a taper that matches corresponds to the taper of aperture 560-1. Outer surface 572 is sized such that lock wedge 540-1 may be inserted into aperture 560-1 and jammed between post 530 and the interior surfaces of aperture 560 of extension 536-1.

In the example illustrated, lock wedge 540-1 comprises a split ring or cylinder having a slot 366 (shown in FIG. 7) that extends along its longitudinal length. The slot facilitates the inner and outer diameter of lock wedge 540-1 to change as it is jammed between post 530 and extension 536-1. The slot may facilitate a tighter frictional contact or grip between lock wedge 540-1 and the engaged post 530 and extension 536-1. In some implementations, the slot may be omitted.

Extension 536-2 comprises a platform upon which a wildlife observer or hunter may stand or rest his or her feet while being elevated along a tree. In the example illustrated, extension 536-2 comprises a main platform portion 574 and a post-mounting portion 576. Main platform comprises a platform having first and second angled edges 548-2 which extend on opposite sides of a cavity 551 that is sized to receive a tree trunk. The platform forming extension 536-2 further comprises first and second grill portions 580 which project rearwardly from the first and second angled edges 548-2. Each of the grill portions 580 comprising open framework upon which a person may stand. Main platform portion 574 further comprises a pair of ears 582 which receive post-mounting portion 575.

Post-mounting portion 575 comprises a structure configured to be removably fastened to main platform portion 574 and to also be connected to post 530. In the example illustrated, post mounting portion 575 is positioned between ears 582 and is fastened to main platform portion 574 by a fastener 584, in the form of a threaded bolt and nut. Fastener 584 may be loosened to permit main platform portion 574 to be pivoted relative to post mounting portion 575, permitting the top surface of main platform portion 574 to be pivoted relative to post 530 between a multitude of available angles relative to post 530. For example, main platform portion 574 may be pivoted to extend in a plane that is oblique to the longitudinal axis of post 530. Once at a desired angular position, fastener 584 may be tightened to secure post mounting portion 575 at a particular selected angle relative to main platform portion 574.

In the example illustrated, tree ascent apparatus 520 additionally comprises a threaded bolt 586 which is threaded into main platform portion 574, which may be raised and lowered by being rotated, and which is configured to about a lower surface of post mounting portion 575. At the selected vertical positioning, bolt 586 may be secured in place using nut 587. In other limitations, other vertically movable and vertically retainer pins or other structures may be used to retain post mounting portion 530 (and post 530) at a selected angle relative to the general plane of main platform portion 574. In other implementations, post mounting portion 575 may be fixedly secured to main platform portion 574 in other fashions or may be integrally formed as a single unitary body with main platform portion 574. In some implementations, post mounting portion 575 may be omitted, wherein an aperture is formed directly within main platform portion 574.

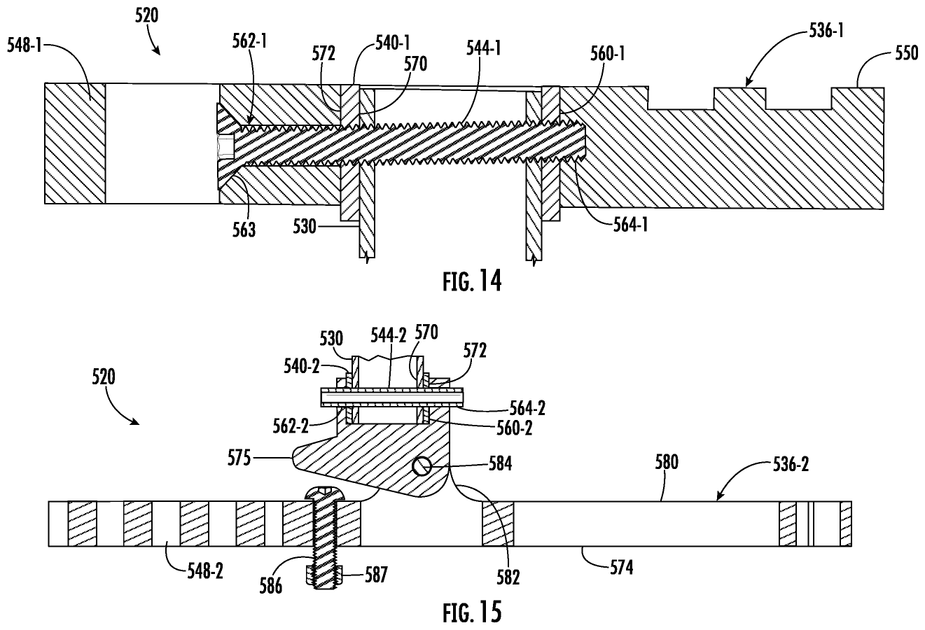

As seen in FIG. 15, post mounting portion 575 of extension 536-2 comprises an aperture 560-2 sized to receive post 530 and to have a wedge 540-2 positioned within the aperture, jammed between the interior surfaces of the aperture 560-2 and the exterior surface of post 530. Aperture 560-2 is generally centered between three grill portions 580, rearward of toothed edges 548-2. As shown by FIG. 15, aperture 560-2 is tapered; the interior diameter of aperture 560-2 gradually changes in a sloped manner, changing from a wider diameter to a smaller diameter. The tapering of aperture 560-2 facilitates reception of lock wedge 540-2 and facilitates the ability of lock wedge 540-2 to accommodate manufacturing variations in the size of aperture 560-2 and the outer diameter of post 530.

The outer surface of lock wedge 540-2 has a shape corresponding to the interior surface of aperture 560-2 formed in extension 536-2. In the example illustrated, outer surface 572 has a taper that matches corresponds to the taper of aperture 560-2. Outer surface 572 is sized such that lock wedge 540-2 may be inserted into aperture 560-2 and jammed between post 530 and the interior surfaces of aperture 560-2 of extension 536-2.

Because the lock wedges 540 occupies and fills any gaps between the interior surfaces of the apertures 560 and the exterior surfaces of the post 530, the lock wedges 540 inhibit relative movement of the extensions 536 with respect to the post 530. Inhibiting or limiting such relative movement reduces rattling or other noise which might otherwise impair wildlife observation or hunting. Moreover, inhibiting or limiting such relative movement reduces those forces upon the post 530 which tend to damage the post 530 over prolonged periods of time. Because the construction may make the post 530 and extensions 536 more robust, the post 530 may be formed from a different lighter weight material that might otherwise be more subject wear, such as a carbon fiber material, or may be formed from a metal, such as aluminum, wherein the wall thickness of the post may be reduced to reduce the overall weight of the tree ascent apparatus 520. In one implementation, post 530 is formed from a carbon fiber material having a wall thickness of no greater than 6 mm. In one implementation, post 530 is formed from a metal, such as aluminum, and has a wall thickness of no greater than 6 mm.

As shown by FIG. 14, fastener 544-1 is similar to fastener 344-1 described above. Fastener 544-1 extends through entry port 562, through lock wedge 540-1, through post 530 and into internally threaded bore 564 to axially secure extension 536-1 along post 530. In the example illustrated, fastener 562 has a head 563 received within a countersunk opening of entry bore 562 and is moved through lock wedge 540-1 and post 530 before being threaded into bore 564. In some implementations, once post 530 has been inserted through bore 560-1 and once lock wedge 540-1 has been wedged between post 530 and extension 536-1, a drill may be guided by entry bore 562 so as a drill through lock wedge 540-1, through post 530 until reaching bore 364. Thereafter, fastener 544-1 is passed through entry bore 562 and through the drilled bore until the threaded portion of fastener 544-1 may be threaded into bore 564.

As shown by FIG. 15, fastener 544-2 is similar to fastener 244 described above. Fastener 544-2 extends through entry port 562-2, through lock wedge 540-2, through post 530 and through bore 564-2 to axially secure extension 536-2 along post 530. In the example illustrated, fastener 544-2 comprises a spring pin (also sometimes referred to as a roll pin). In some implementations, once post 530 has been inserted through bore 560-1 and once lock wedge 540-1 has been wedged between post 530 and extension 536-1, a drill may be guided by entry bore 562 so as a drill through lock wedge 540-1, through post 530 and into extension 536-2 to form bore 564-2. Thereafter, fastener 544-2 is passed through entry bore 562-2 and through the drilled bore into bore 564-2.

Cleat 541 projects from post 330 in a direction generally opposite to the direction in which side opening channels 342-1 and 342-2 face. Cleat 541 is secured to post 530 and has a head portion 585 and a narrower neck portion 587 about which a strap, rope, cable the like may be wrapped and retained. In some implementations, cleat 541 may be omitted.

In some implementations, cleat 541 may be secured to post 330 using a lock wedge, similar to the lock wedge is used to secure claws 336 to post 330. In particular, cleat 541 may include an aperture, similar to bore 560-1, which receives a lock wedge, similar to lock wedge 540-1 or 540-2, which is wedge between post 530 and the interior surfaces of the aperture.

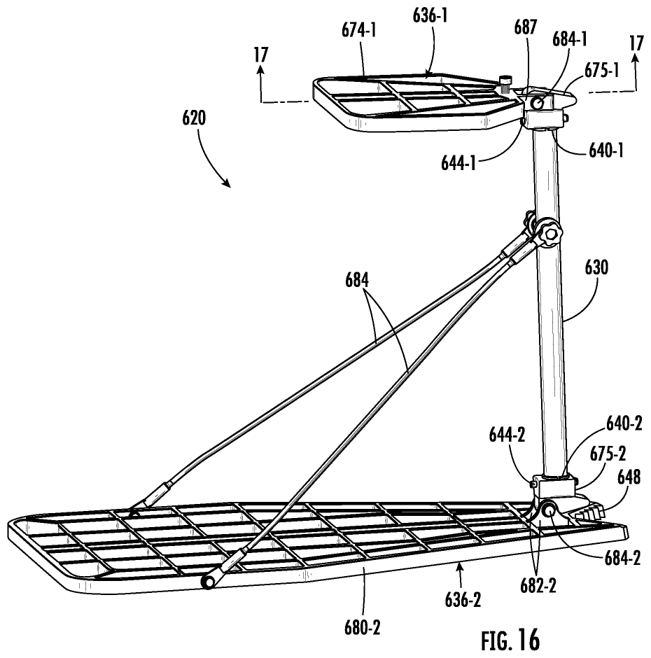

FIG. 16 is a perspective view illustrating portions of an example tree ascent apparatus 620. FIG. 16 illustrates an example of how the above-described lock wedge and fastener may be used to secure and retain extensions in the form of a platform and a seat on a tree stand. Tree ascent apparatus comprises post 630, extensions 636-1, 636-2 (collectively referred to as extension 636), lock wedges 640-1, 640-2 (collectively referred to as lock wedges 640), fasteners 644-1, 644-2, and strut cables 684.

Post 630 is similar to post 530 except the post 630 extends between extensions 636. Post 630 includes an intermediate portion supporting strut cables 684. Post 630 comprises an elongate tubular structure configured to extend generally along a tree trunk while supporting extensions 636. Post 630 may be secured against the tree trunk by one or more claws, straps or the like. Post 630 may have a circular, oval or polygon cross-sectional shape with a hollow interior. In some implementations, the hollow interior may be filled with another material such as a foam. Post 630 may be formed from a non-fiber material that is a lower density and is lighter in weight than a metal material, or a metal but wherein has a reduced wall thickness, taking advantage of the additional structural integrity provided by lock wedges 640. In some implementations, post 630 is formed from an aluminum or aluminum alloy and has a wall thickness of no greater than 6 mm.

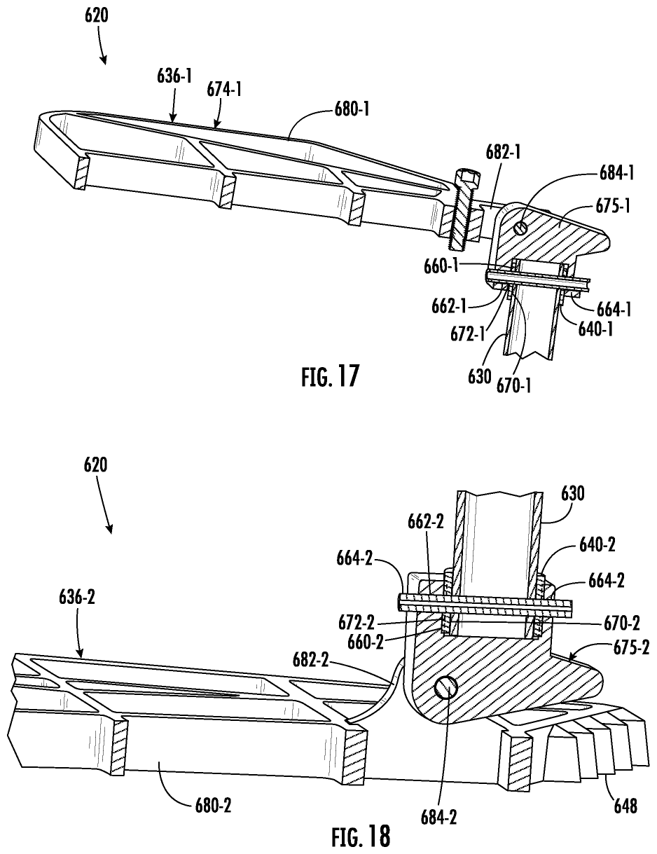

Extension 636-1 projects to one side of post 630. In the example illustrated, extension 636-1 comprises an open grill framework. Extension 636-1 is sized to serve as a seat. As shown by FIG. 17, extension 636-1 comprises a main platform portion 674-1 and a post-mounting portion 675-1.

Main platform portion 674-1 comprises a grill portion 680-1 which projects rearwardly from the post mounting portion 675-1. Grill portion 680-1 comprises an open framework upon which a person may be seated. In other implementations, main platform portion 674-1 may comprise an imperforate panel, a cushioned seat area or the like. Main platform portion 674-1 further comprises a pair of ears 682-1 which receive post-mounting portion 675-1.

Post-mounting portion 675-1 comprises a structure configured to be removably fastened to main platform portion 674-1 and to also be connected to post 630. In the example illustrated, post mounting portion 675-1 is positioned between ears 682-1 and is fastened to main platform portion 674-1 by a fastener 684-1, in the form of a threaded bolt and nut. Fastener 684-1 may be loosened to permit main platform portion 674-1 to be pivoted relative to post mounting portion 675-1, permitting the top surface of main platform portion 674-1 to be pivoted relative to post 630 between a multitude of available angles relative to post 630. For example, main platform portion 674-1 may be pivoted to extend in a plane that is oblique to the longitudinal axis of post 630. Once at a desired angular position, fastener 684-1 may be tightened to secure post mounting portion 675-1 at a particular selected angle relative to main platform portion 674-1.

As seen in FIG. 17, post mounting portion 675-1 of extension 636-1 comprises an aperture 660-2 sized to receive post 630 and to have a wedge 640-1 positioned within the aperture, jammed between the interior surfaces of the aperture 660-1 and the exterior surface of post 630. In the example illustrated, aperture 660-1 is tapered; the interior diameter of aperture 660-1 gradually changes in a sloped manner, changing from a wider diameter to a smaller diameter. The tapering of aperture 660-1 facilitates reception of lock wedge 640-1 and facilitates the ability of lock wedge 640-1 to accommodate manufacturing variations in the size of aperture 660-1 and the outer diameter of post 630.

Lock wedges 640 each generally comprise a cylindrical tube or ring that is split, having a slot 366 extending along its length (similar to that of lock wedge 340-1 shown in FIG. 7). The outer surface of lock wedge 640-1 has a shape corresponding to the interior surface of aperture 660-1 formed in the post mounting portion 675-1 of extension 636-1. In the example illustrated, outer surface 672-1 has a taper that matches corresponds to the taper of aperture 660-1. Outer surface 672-1 is sized such that lock wedge 640-1 may be inserted into aperture 660-1 and jammed between post 630 and the interior surfaces of aperture 660-1 of extension 636-1. In the example illustrated, the inner surface 670-1 of lock wedge 640-1 is not tapered but has a uniform inner diameter along its length corresponding to the opposite generally uniform outer diameter of post 630. The slot or split in lock wedge 640-1 facilitates compression of the lock wedge as it is being jammed between post 630 and aperture 660-2 such that the inner diameter of lock wedge 640-1 may change to match or press against the outer diameter of post 630.

As shown by FIG. 17, fastener 644-1 is similar to fastener 244 described above. Fastener 644-1 extends through entry port 662-1, through lock wedge 640-1, through post 630 and through bore 664-1 to axially secure extension 636-1 along post 630. In the example illustrated, fastener 644-1 comprises a spring pin (also sometimes referred to as a roll pin). In other implementations, fastener 644-1 may comprise other forms of a fastener, such as the fastener 544-1 described above. In some implementations, once post 630 has been inserted through bore 660-1 and once lock wedge 640-1 has been wedged between post 630 and extension 636-1, a drill may be guided by entry bore 662 so as a drill through lock wedge 640-1, through post 630 and into extension 636-1 to form bore 664-1. Thereafter, fastener 644-1 is passed through entry bore 662-1 and through the drilled bore into bore 664-1.

Extension 636-2 projects from post 630 in the same direction as extension 636-1. In the example illustrated, extension 636-2 comprises an open grill framework. Extension 636-2 is sized to serve as a platform upon which a person may stand or rest his or her feet. As shown by FIG. 18, extension 636-2 comprises a main platform portion 674-2 and a post-mounting portion 675-2.

Main platform portion 674-2 comprises a claw portion having a toothed edge 648 configured to face the side of a tree and grip the side of the tree and a grill portion 680-2. Grill portion 680-2 projects rearwardly from the post mounting portion 675-2. Main platform portion 674-2 further comprises a pair of ears 682-2 which receive post-mounting portion 675-2.

Post-mounting portion 675-2 comprises a structure configured to be removably fastened to main platform portion 674-2 and to also be connected to post 630. In the example illustrated, post mounting portion 675-2 is positioned between ears 682-2 and is fastened to main platform portion 674-2 by a fastener 684-2, in the form of a threaded bolt and nut. Fastener 684-2 may be loosened to permit main platform portion 674-2 to be pivoted relative to post mounting portion 675-2, permitting the top surface of main platform portion 674-2 to be pivoted relative to post 630 between a multitude of available angles relative to post 630. For example, main platform portion 674-2 may be pivoted to extend in a plane that is oblique to the longitudinal axis of post 630. Once at a desired angular position, fastener 684-2 may be tightened to secure post mounting portion 675-2 at a particular selected angle relative to main platform portion 674-2.

As seen in FIG. 18, post mounting portion 675-2 of extension 636-2 comprises an aperture 660-2 sized to receive post 630 and to have a wedge 640-2 positioned within the aperture, jammed between the interior surfaces of the aperture 660-2 and the exterior surface of post 630. In the example illustrated, aperture 660-2 is tapered; the interior diameter of aperture 660-2 gradually changes in a sloped manner, changing from a wider diameter to a smaller diameter. The tapering of aperture 660-2 facilitates reception of lock wedge 640-2 and facilitates the ability of lock wedge 640-2 to accommodate manufacturing variations in the size of aperture 660-2 and the outer diameter of post 630.

The outer surface of lock wedge 640-2 has a shape corresponding to the interior surface of aperture 660-2 formed in the post mounting portion 675-2 of extension 636-2. In the example illustrated, outer surface 672-2 has a taper that matches corresponds to the taper of aperture 660-2. Outer surface 672-2 is sized such that lock wedge 640-2 may be inserted into aperture 660-2 and jammed between post 630 and the interior surfaces of aperture 660-2 of extension 636-1. In the example illustrated, the inner surface 670-2 of lock wedge 640-2 is not tapered but has a uniform inner diameter along its length corresponding to and slightly larger than the opposite generally uniform outer diameter of post 630. The slot or split in lock wedge 640-2 facilitates compression of the lock wedge as it is being jammed between post 630 and aperture 660-2 such that the inner diameter of lock wedge 640-2 may change to match or press against the outer diameter of post 630.

As shown by FIG. 18, fastener 644-2 is similar to fastener 244 described above. Fastener 644-2 extends through entry port 662-2, through lock wedge 640-2, through post 630 and through bore 664-2 to axially secure extension 636-2 along post 630. In the example illustrated, fastener 644-2 comprises a spring pin (also sometimes referred to as a roll pin). In other implementations, fastener 644-2 may comprise other forms of a fastener, such as the fastener 544-1 described above. In some implementations, once post 630 has been inserted through bore 660-1 and once lock wedge 640-2 has been wedged between post 630 and extension 636-2, a drill may be guided by entry bore 662 so as a drill through lock wedge 640-2, through post 630 and into extension 636-1 to form bore 664-2. Thereafter, fastener 644-2 is passed through entry bore 662-2 and through the drilled bore into bore 664-2.

In some implementations, extension 636-1 and/or extension 636-2 may be integrally formed or fixedly joined to their respective main platform portion 674. In some implementations, extension 636-1 and/or extension 636-2 may omit post mounting portions 675, wherein the apertures 660 are directly formed in the structure serving as the main platform portion 675.

Struct cables 684 comprises flexible bands, straps, cords or cables angularly extending between post 630 and main platform portion 680-2 of extension 636-2. Struct cables 684 assist in supporting extension 636-2 from post 630. Because cables 684 are flexible, post 630 may be pivoted and folded relative to platform portion 680-2 for compact storage and transport of apparatus 620. In other implementations, struts 68 comprise rigid bars or rods having opposite ends affixed to post 630 and main platform portion 680-2 of extension 636-2.

Because the lock wedges 640 occupy and fill any gaps between the interior surfaces of the apertures 660 and the exterior surfaces of the post 630, the lock wedges 640 inhibit relative movement of the extensions 636 with respect to the post 530. Inhibiting or limiting such relative movement reduces rattling or other noise which might otherwise impair wildlife observation or hunting. Moreover, inhibiting or limiting such relative movement reduces those forces upon the post 630 which tend to damage the post 630 over prolonged periods of time. Because the construction may make the post 630 and extensions 636 more robust, the post 630 may be formed from a different lighter weight material that might otherwise be more subject wear, such as a carbon fiber material, or may be formed from a metal, such as aluminum, wherein the wall thickness of the post may be reduced to reduce the overall weight of the tree ascent apparatus 620. In one implementation, post 630 is formed from a carbon fiber material having a wall thickness of no greater than 6 mm. in one implementation, post 630 is formed from a metal, such as aluminum, and has a wall thickness of no greater than 6 mm.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A tree ascent apparatus comprising:
a post;
an extension supported by the post, the extension having an aperture receiving the post; and
a lock wedge having a tapered surface, the lock wedge being jammed in the aperture between the post and the extension.

2. The tree ascent apparatus of claim 1, wherein the lock wedge comprises a split cylinder having an outer tapered surface.

3. The tree ascent apparatus of claim 1, wherein the post has a circular cross-section.

4. The tree ascent apparatus of claim 1, wherein the post is formed from a carbon fiber.

5. The tree ascent apparatus of claim 1, wherein the extension comprises a tree gripping claw.

6. The tree ascent apparatus of claim 1, wherein the tree ascent apparatus comprises a climbing stick and wherein the extension comprises a step.

7. Tree ascent apparatus of claim 1, wherein the extension comprises:
first and second angled edges having tree gripping teeth; and
first and second grill portions projecting rearwardly from the first and second angled edges, respectively, to form a step, wherein the aperture is centered between the first and second grill portions.

8. The tree ascent apparatus of claim 1, wherein the tree ascent apparatus comprises a tree stand and wherein the extension comprises one of a platform and a seat.

9. The tree ascent apparatus of claim 1 further comprising a fastener extending through the extension, through the lock wedge and through the post.

10. The tree ascent apparatus of claim 7, wherein the extension comprises an internally threaded bore and wherein the fastener comprises an externally threaded shaft that is screwed into the internally threaded bore.

11. The tree ascent apparatus of claim 7, wherein the fastener comprises a roll pin.

12. The tree ascent apparatus of claim 1, wherein the post has a cylindrical outer circumferential surface and wherein the lock wedge comprises a ring having a cylindrical inner circumferential surface and a tapered outer circumferential surface.

13. The tree ascent apparatus of claim 1 further comprising:
second extension supported by the post, the extension having a second aperture receiving the post; and
a second lock wedge having a tapered surface, the second lock wedge being jammed in the second aperture between the post and the second extension.

14. The tree ascent apparatus of claim 13, wherein the post has a circular cross-section, is formed from aluminum and has a wall thickness no greater than 6 mm.

15. The tree ascent apparatus of claim 14, wherein the post has a circular cross-section and is formed from a carbon fiber.

16. The tree ascent apparatus of claim 15, wherein the extension comprises a platform and wherein the second extension comprises a seat.

17. The tree ascent apparatus of claim 15, wherein the extension comprises a first step having first tree gripping toothed edges and wherein the second extension comprises a second step having second tree gripping toothed edges.

18. The tree ascent apparatus of claim 1, wherein the extension comprises an entry bore on a first side of the aperture and an exit bore on a second side of the aperture and wherein the apparatus further comprises a fastener extending within the entry bore and the exit bore and extending through the post and the lock wedge.

19. The tree ascent apparatus of claim 18, wherein the exit bore is internally threaded.

20. A method for forming a tree ascent apparatus, the method comprising:
inserting a post through an aperture in an extension configured as one of a platform, a seat, a tree gripping claw and a step; and
jamming a lock wedge in the aperture between the post and the extension.

21. The method of claim 20, wherein the extension comprises preformed bores on opposite sides of the aperture, the method further comprising:
drilling a passage through the lock wedge and through the passage, using one of the preformed bores as a guide, and positioning a fastener through the drilled passage and through the preformed bores.
